(19) United States
(12) Patent Application Publication
(10) Pub. No.: US 2009/0279153 A1
(43) Pub. Date: Nov. 12, 2009

(54) HOLOGRAM RECORDING/REPRODUCING DEVICE, HOLOGRAM RECORDING/REPRODUCING METHOD, AND HOLOGRAM RECORDING MEDIUM

(75) Inventors: Yasumasa Iwamura, Kawasaki (JP); Koichi Tezuka, Kawasaki (JP); Hiroyasu Yoshikawa, Kawasaki (JP); Kazushi Uno, Kawasaki (JP); Yuzuru Yamakage, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/507,643

(22) Filed: Jul. 22, 2009

Related U.S. Application Data
(63) Continuation of application No. PCT/JP2007/051147, filed on Jan. 25, 2007.

(51) Int. Cl. G03H 1/26

(52) U.S. Cl. 359/22

(57) ABSTRACT

The hologram recording/reproducing apparatus is for recording a hologram by emitting a recording beam (S) modulated by a spatial light modulator and a reference beam (R) having a same wavelength as the recording beam onto a hologram recording medium (B) so that the beams overlap each other with polarization direction (p) of the beams being matched to interfere with each other, and for reproducing the hologram by exposing the hologram recording medium storing the hologram to the reference beam to generate diffracted light and receiving the diffracted light by an imaging device. The spatial light modulator is controlled so as to form a data area (H0) corresponding to information to be recorded and a plurality of mark areas (H1) for detecting a position of the data area in the hologram recording medium (B) in recording of the hologram. The mark areas (H1) are formed at positions not to be overlapped by a beam scattering region which may be generated along a polarizing direction (p) of the reference beam on an outward side of the data area (H0).

### TECHNICAL FIELD

This application is a Continuation of International Application Serial No. PCT/JP2007/051147, filed Jan. 25, 2007.

The present invention relates to a hologram recording/reproducing apparatus, a hologram recording/reproducing method and a hologram recording medium for recording holograms and reproducing holograms.

### BACKGROUND ART

A conventional hologram recording/reproducing apparatus is disclosed in Patent Document 1, for example. In this hologram recording/reproducing apparatus, a laser beam emitted from a laser beam source is split by a beam splitter into a recording beam and a reference beam. The recording beam is modulated by a spatial light modulator and then a hologram recording medium is exposed to the modulated beam while simultaneously the reference beam is irradiated so as to interfere with the recording beam. The recording beam and the reference beam are arranged to have the same polarizing direction considering optical conditions such as coherency. The hologram recording/reproducing apparatus employs a method called shift multiplex recording method in which pages, which is units of recording, are partially overlapped in recording. As described in “Background Art” in the Patent Document 1, the apparatus of this type typically forms a bit-pattern hologram (data portion) corresponding to information to be recorded and markers each of which indicates respective one of the four corners of the hologram. In reproducing, the markers are used to specify the position of the data portion to be read out.

Patent Document 1: Japanese Laid-open Patent Publication No. 2005-99283

However, in hologram recording with a recording beam and a reference beam having the same polarizing direction, when the hologram is reproduced, it is known that a beam scattering region is generated at the both sides outside the hologram with directivity of the polarizing direction of the reference beam same as that of the recording beam. The beam scattering region is caused by diffracted beams due to noise grating. If optical intensity of the beam scattering region is relatively high and the markers are overlapped by the beam scattering region, the markers are not able to be detected at all, whereby read out error occurs because the data portion cannot be read out. In the above-described conventional hologram recording/reproducing apparatus, no measures have been taken about such a beam scattering region.

### DISCLOSURE OF THE INVENTION

The present invention has been proposed under the above-described circumstances. It is, therefore, an object of the present invention to provide a hologram recording/reproducing apparatus and a hologram recording/reproducing method capable of avoiding errors in reading even if a beam scattering region appears.

In order to solve the above-described problems, the present invention makes use of the following technical means.

According to the first aspect of the present invention, there is provided a hologram recording/reproducing apparatus for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device, wherein the spatial light modulator is controlled so as to form a data area corresponding to information to be recorded and a plurality of mark areas for detecting a position of the data area in the hologram recording medium in recording of the hologram, the mark areas being formed at positions not to be overlapped by a beam scattering region which may be generated along a polarizing direction of the reference beam on an outward side of the data area.

According to the second aspect of the present invention, there is provided a hologram recording/reproducing apparatus for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device, wherein the spatial light modulator is controlled so as to form a data area corresponding to information to be recorded and a plurality of mark areas for detecting a position of the data area in the hologram recording medium in recording of the hologram, and wherein the hologram recording/reproducing apparatus further comprises a polarizer on an optical path of at least one of the recording beam and the reference beam, the polarizer being utilized for matching polarizing direction of the recording beam and the reference beam in recording, and for determining the polarizing direction so as not to cause any of the mark areas to be overlapped by a beam scattering region which may appear along the polarizing direction of the reference beam on an outward side of the data area.

Preferably, the spatial light modulator forms the mark areas adjacent to the data area.

Preferably, the hologram recording/reproducing apparatus is capable of performing multiple recording of holograms including the data area and the mark areas by using an angular multiple method, a wavelength multiple method, a shift multiple method, a speckles multiple method or a phase code multiple method.

Preferably, the spatial light modulator forms the data area in a polygonal shape and the mark areas at a plurality of positions from which corners of the data area are locatable.

According to the third aspect of the present invention, there is provided a hologram recording/reproducing method for recording a hologram by emitting a recording beam modulated by a spatial light modulator and a reference beam having a same wavelength as the recording beam onto a hologram recording medium so that the beams overlap each other with polarizing direction of the beams being matched to interfere with each other, and for reproducing the hologram by exposing the hologram recording medium storing the hologram to the reference beam to generate diffracted light and receiving the diffracted light by an imaging device, wherein the spatial light modulator is controlled so as to form a data area corresponding to information to be recorded and a plurality of mark areas adjacent to the data area for detecting a position of the data area in the hologram recording medium in recording of the hologram, the mark areas being formed at positions not to be overlapped by a beam scattering region which may be generated along a polarizing direction of the reference beam on an outward side of the data area.

According to the fourth aspect of the present invention, there is provided a hologram recording/reproducing method for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device, wherein the spatial light modulator is controlled so as to form a data area corresponding to information to be recorded and a plurality of mark areas adjacent to the data area for detecting a position of the data area in the hologram recording medium in recording of the hologram, and polarizing direction of the recording beam and the reference beam are matched, and the polarizing direction of at least one of the recording beam and the reference beam is determined so as not to cause any of the mark areas to be overlapped by a beam scattering region which may appear along the polarizing direction of the reference beam on an outward side of the data area.

According to the fifth aspect of the present invention, there is provided a hologram recording medium to be used in a hologram recording/reproducing apparatus for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device, wherein a data area corresponding to information to be recorded and a plurality of mark areas for detecting a position of the data area are formed in recording of the hologram in the hologram recording medium, the mark areas being formed at positions not to be overlapped by a beam scattering region which may be generated along a polarizing direction of the reference beam on an outward side of the data area.

### BRIEF DESCRIPTION OF THE DRAWINGS

FIG. 1 is a configuration diagram illustrating an embodiment of a hologram recording/reproducing apparatus according to the present invention.

FIG. 2 is an explanatory diagram of a recording operation performed by the hologram recording/reproducing apparatus in FIG. 1.

FIG. 3 is an explanatory diagram of a reproducing operation performed by the hologram recording/reproducing apparatus in FIG. 1.

FIG. 4 is an explanatory diagram of another recording pattern.

FIG. 5 is a configuration diagram illustrating another embodiment of a hologram recording/reproducing apparatus according to the present invention.

FIG. 6 is an explanatory diagram of a recording method in another embodiment of a hologram recording/reproducing apparatus according to the present invention.

FIG. 7 is a configuration diagram illustrating another embodiment of a hologram recording/reproducing apparatus according to the present invention.

FIG. 8 is a configuration diagram illustrating another embodiment of a hologram recording/reproducing apparatus according to the present invention.

### BEST MODE FOR CARRYING OUT THE INVENTION

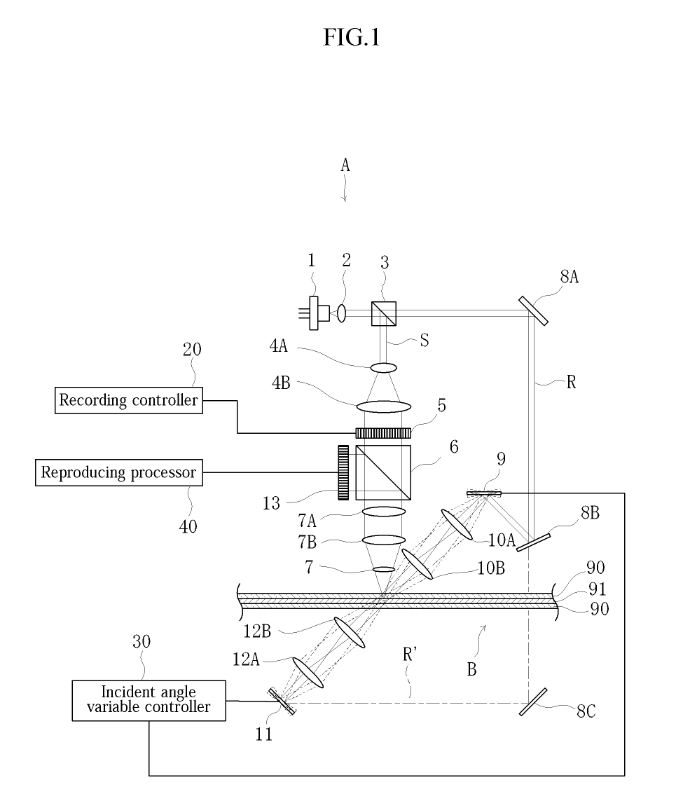

Hereinafter, preferred embodiments of the present invention will be described with reference to the drawings. FIGS. 1 to 3 illustrate an embodiment of a hologram recording/reproducing apparatus according to the present invention.

As illustrated in FIG. 1, a hologram recording/reproducing apparatus A according to the present embodiment records or reproduces a hologram by a method called angular multiplex method. The hologram recording/reproducing apparatus A includes, as components of the optical system, a light source 1, a collimator lens 2, a half mirror 3, beam expanders 4A, 4B, a spatial light modulator 5, a beam splitter 6, relay lenses 7A, 7B, an objective lens 7, fixed mirrors 8A, 8B, 8C, a recording galvanometer mirror 9, recording relay lenses 10A, 10B, a reproducing galvanometer mirror 11, reproducing relay lenses 12A, 12B, and an imaging device 13. These optical system components are mounted on an unillustrated pickup. The spatial light modulator 5 is controlled by a recording controller 20. The recording and reproducing galvanometer mirrors 9, 11 are controlled by an incident angle variable controller 30. The imaging device 13 is connected with a reproducing processor 40. The other unillustrated components include a rotation mechanism for rotating a disc-shaped hologram recording medium B, a tracking servo mechanism for moving the pickup unit radially of the hologram recording medium B, and a microcomputer which controls the entire operation. The recording controller 20, the incident angle variable controller 30 and the reproducing processor 40 are connected with the microcomputer.

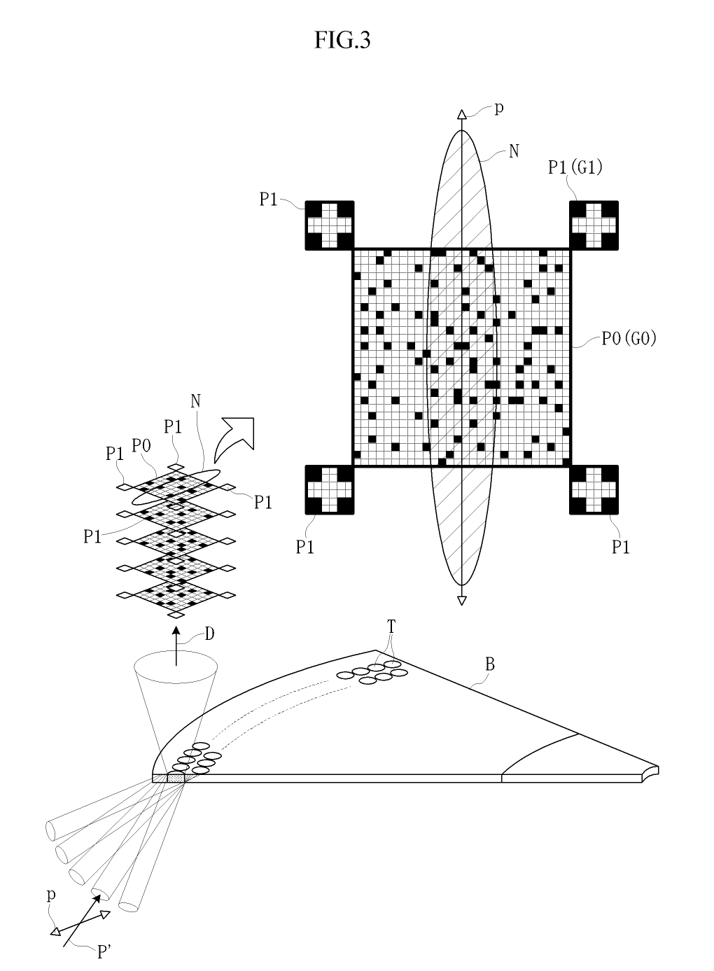

The hologram recording medium B has a recording layer 91 between two transparent protective layers 90, so that light can reach the recording layer 91 from both sides. In the recording layer 91, a recording beam S and a reference beam R intersect with each other at predetermined angles and interfere with each other, whereby holograms each having a different interference fringe pattern in accordance with the crossing angle are recorded. In reproducing, as indicated by long-and-short-dash lines, the hologram recording medium B is exposed to a reference beam R′ traveling from the opposite side to that in recording. The reference beam R′ is conjugate to the recording reference beam R. In the recording layer 91, therefore, the reference beam R′ makes interference with recorded holograms, and a diffracted beam D (see FIG. 3) is generated. The diffracted beam D travels through the objective lens 7 and the beam splitter 6, and is received by the imaging device 13.

The light source 1, which is e.g. a semiconductor laser device, emits a laser beam as a coherent beam in recording and reproducing. The collimator lens 2 converts the laser beam from the beam source 1 into a parallel light. The parallel light which comes out of the collimator lens 2 is guided to the half mirror 3. The half mirror 3 splits the incoming parallel light into a recording beam S which travels to the spatial light modulator 5, and reference beams R, R′ which travel on their own routes to the recording or the reproducing galvanometer mirrors 9, 11 respectively. Thus, the reference beams R, R′ always have the same wavelength as the recording beam S. Further, the recording beam S and the reference beams R, R′ have the same polarizing direction. The beam expanders 4A, 4B are provided by combination lenses, and direct the recording beam S to the spatial light modulator 5 while increasing the diameter of the recording beam S.

The spatial light modulator 5, which is e.g. a transmissive liquid-crystal display device, modulates a beam which incomes in recording into a recording beam S which has a two-dimensional pixel pattern. The recording controller 20 controls the spatial light modulator 5 for generating different holograms in accordance with information which is to be recorded.

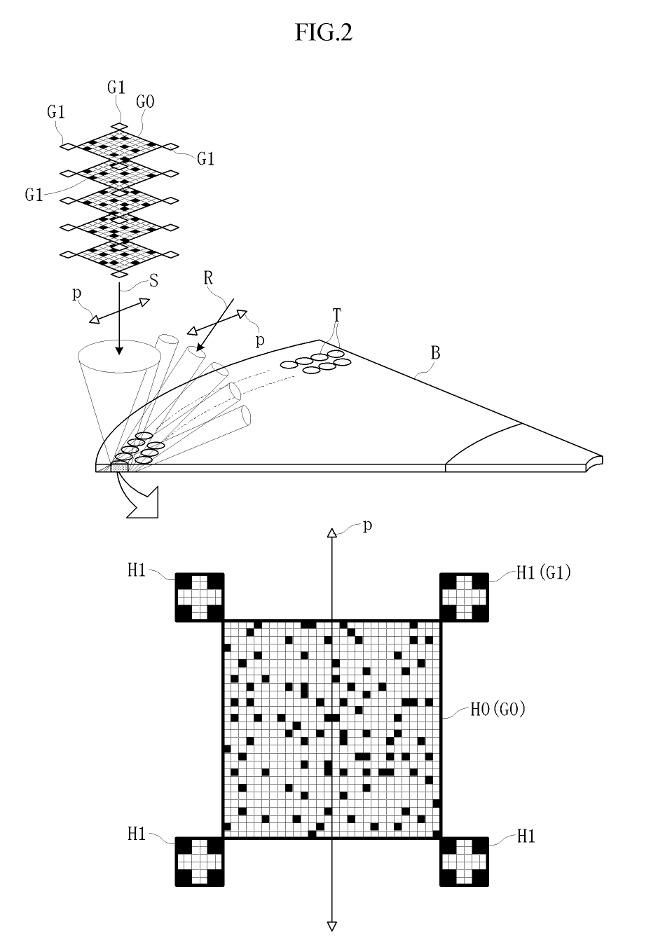

Specifically, as illustrated in FIG. 2 as an example, the spatial light modulator 5 forms a rectangular data pixel area G0 corresponding to information to be recorded, such as an image or a text, and four mark pixel areas G1 adjacent to four corners of the data pixel area G0 for detecting the data pixel area.

According to the data pixel area G0, a data area H0 is formed in an area of the hologram corresponding to this, and according to the mark pixel areas G1, mark areas H1 are formed at four corners of the data area H0 in an area of the hologram corresponding to this. The mark areas H1 are used as indices indicating position of the data area H0, and also used to store address information. The address information includes, for example, information for determining the incident angles of the reference beams R, R′. In recording, the recording beam S and the reference beam R are arranged to have a matched polarizing direction, so that both of the beams have a vertical polarization for example. Alternatively, the beams may be arranged to have a horizontal polarization. The four mark areas H1 are formed not to be overlapped by a line (hereinafter referred to as “polarization line”) p extending in the polarization direction of the recording beam S and passing through the center of the data area H0. That is, at the spatial light modulator 5, the mark pixel areas Glare formed at locations which are determined from a positional relationship between the data pixel area G0 and the polarization line p. Although the mark pixel areas G1 are formed adjacent to the data pixel area G0 in the present embodiment, the mark pixel areas G1 may be formed at a predetermined distance from the data pixel area G0. Further, although the data pixel area G0 is a rectangle in the present embodiment, it may be a polygon, such as a triangle, a hexagon, and so on.

Back to FIG. 1, after being emitted from the spatial light modulator 5, the recording beam S is guided through the beam splitter 6 to the relay lenses 7A, 7B and the objective lens 7, and finally reaches the hologram recording medium B. In this process, the reference beam R emitted from the half mirror 3 is guided via the fixed mirrors 8A, 8B to the recording galvanometer mirror 9, reflects on the galvanometer mirror 9, passes by the relay lenses 10A, 10B, and then reaches the hologram recording medium B so as to interfere with the recording beam S. As illustrated in FIG. 2, each of the unit recording areas T is exposed to the recording beam S and the reference beam R overlapping each other. In the present embodiment, unit recording areas T are formed in the circumferential direction without overlapping each other. The recording beam S impinges on each of the unit recording areas T substantially at a right angle (incident angle 0). On the other hand, the reference beam R travels from an obliquely upper side, and the incident angle of the reference beam R is varied by operation of the galvanometer mirror 9. Thus, multiplex holograms are recorded in the angular multiplex method.

In reproducing, the reference beam R′ is guided via the fixed mirror 8C to the reproducing galvanometer mirror 11. The reproducing galvanometer mirror 11 varies the incident angle of the reference beam R′ relative to the unit recording area T in reproducing. The galvanometer mirror 11 is so arranged that the reference beam R′ impinges on the hologram recording medium B from the opposite side to that in recording. After being emitted from the reproducing galvanometer mirror 11, the reference beam R′ is a conjugate beam which travels in the opposite direction to that in recording, and this reference beam R′ passes by the relay lenses 12A, 12B and reaches the hologram recording medium B. The reference beam R′ for reproducing is also arranged to have a matched polarizing direction with the polarizing direction of the recording beam S and the reference beam R. In the reproducing process, the spatial light modulator 5 is controlled so that the unit recording areas T is not exposed to the recording beam S.

As illustrated in FIG. 3, when the hologram recording medium B is exposed to the reference beam R′, a diffracted light D is generated in accordance with a hologram corresponding to the incident angle. The diffracted light D travels in the opposite direction to that of the recording beam S and is guided to the beam splitter 6, and then received by the imaging device 13 via the beam splitter 6 (see FIG. 1). The imaging device 13, which is e.g. a CMOS image sensor, detects the four mark pixel patterns P1 corresponds to the mark areas H1 from the incoming diffracted beam D. When information about these mark pixel patterns P1 is transmitted to the reproducing processor 40, exposure position or incident angle of the reference beam R′ is properly adjusted by the reproducing galvanometer mirror 11, and then the imaging device 13 detects a data pixel pattern P0 corresponding to the data area H0. The data pixel pattern P0 corresponds to the pixel pattern of the data pixel area G0 in recording, whereas the mark pixel patterns P1 corresponds to the pixel patterns of the mark pixel areas G1. In this way, the reproducing processor 40 reproduces the information recorded in the data area H0, specifying location of the data area H0 based on the mark areas H1.

In a hologram reproducing process described above, a beam scattering region N may be generated with directivity of the polarizing direction of the reference beam P′ at both sides outward of the hologram. The beam scattering region N is caused by diffracted beams due to noise grating, and generated along the polarization line p. The beam scattering region N overlaps partially the data pixel pattern P0, but does not overlap any of the four mark pixel patterns P1. Therefore, the mark pixel patterns P1 can be surely detected, and the data pixel pattern P0 corresponding to the data area H0 can be obtained by specifying at least the position of the data area H0. In other words, the mark pixel areas G1 formed in the spatial light modulator 5 is configured to be positioned not to overlap the polarization line p, taking the beam scattering region N to generate in reproducing into consideration.

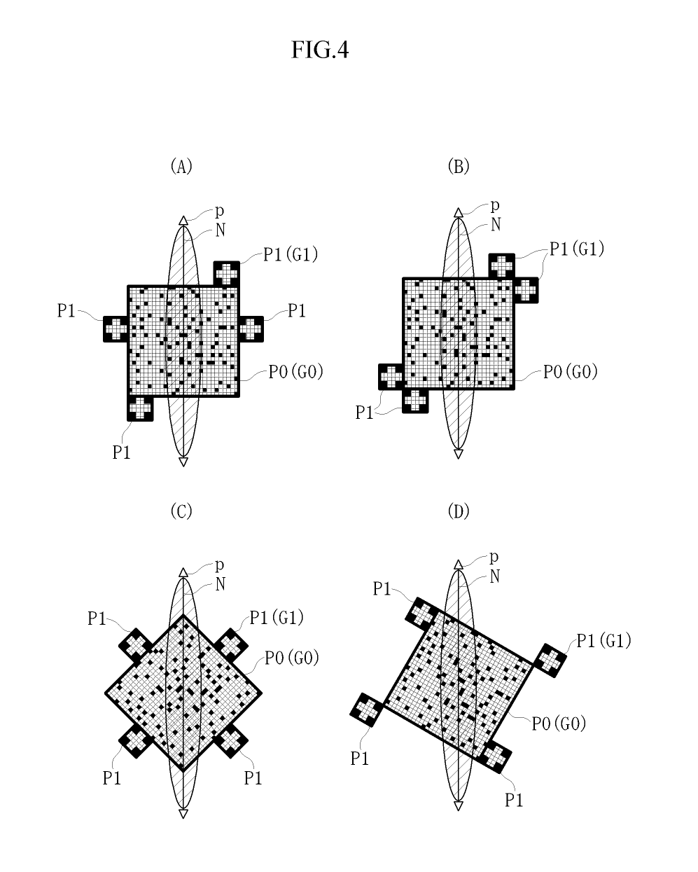

The other layout patterns for the data pixel area G0 and the mark pixel areas G1 include various layout patterns in which none of the mark pixel areas G1 overlap the polarization line p and the location of the data pixel area G0 is specified by the mark pixel areas G1, as illustrated in FIGS. 4(A) through FIG. 4(D).

Next, recording and reproducing operation performed by the hologram recording/reproducing apparatus A will be described below.

First, in recording, as illustrated in FIG. 2, the incident angle of the reference beam R is varied intermittently according to the operation of the recording galvanometer mirror 9. When the incident angle becomes equal to one of predetermined angles, a recording beam S is emitted.

In this process, the recording beam S is modulated by the spatial light modulator 5 into light which corresponds to the data pixel area G0 and the mark pixel areas G1. Thus, a data area H0 and mark areas H1 corresponding to the data pixel area G0 and the mark pixel areas G1 are recorded in multiple in a unit recording area T of the hologram recording medium B. The mark areas H1 are formed at four corners of the data area H0 without overlapping the polarization line p.

Next, in reproducing, as illustrated in FIG. 3, the incident angle of the reference beam R′ is varied by operation of the reproducing galvanometer mirror 11.

In this process, when the incident angle of the reference beam R′ becomes equal to the incident angle of recording, the imaging device 13 detects the mark pixel patterns P1 corresponding to the mark areas H1 located at the four corners of the data area H0. At this time, the imaging device 13 unavoidably detects the beam scattering region N. However, since the mark pixel patterns P1 are in the positions not overlapping the beam scattering region N, the four mark pixel patterns P1 are detected reliably.

Once the mark pixel patterns P1 are detected in this way, the position of the data area H0 is determined, and the exposure position or the incident angle of the reference beam R′ is adjusted finely based on the determined position. Therefore, the imaging device 13 is able to read the data pixel pattern P0 corresponding to the data area H0. By repeating the series of operations described above, the information is read out in the form of data pixel pattern P0 from a plurality of data areas H0 stored in multiple recording.

Therefore, with the hologram recording/reproducing apparatus A according to the present embodiment, it is possible to read the mark areas H1 reliably even if a beam scattering region N is generated by diffracted light due to so-called noise grating during the reproduction operation. This makes possible to specify the location of the data area H0 for reading out, avoiding errors in reading in the reproducing operation.

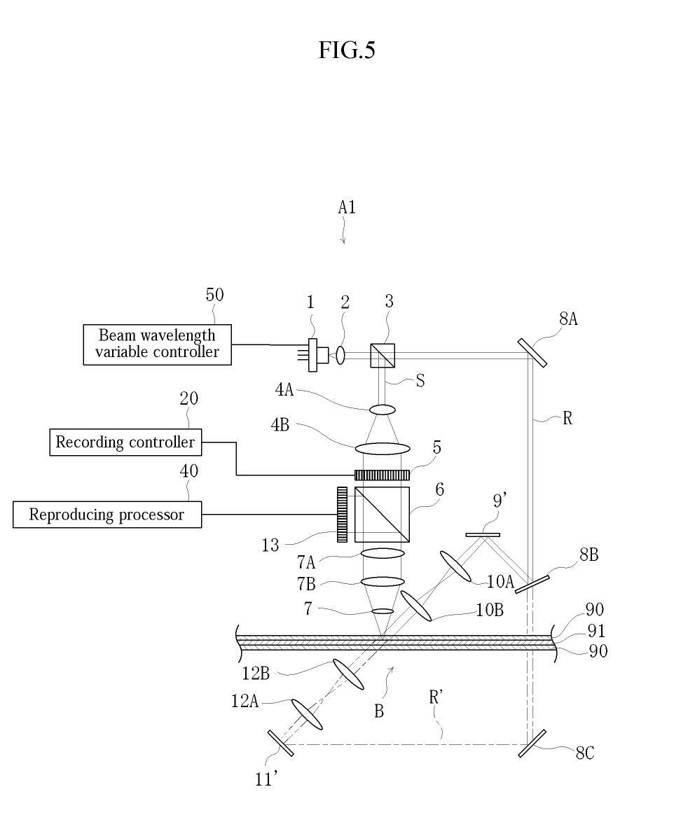

The other embodiments can include hologram recording/reproducing apparatuses as illustrated in FIGS. 5 to 8. The elements which are identical to those of the foregoing embodiment are designated by the same reference signs as those used for the foregoing embodiment, and the explanation will be omitted about such elements.

The hologram recording/reproducing apparatus A1 in FIG. 5 performs multiple recording by variably controlling the wavelength of the laser beam, and includes a beam wavelength variable controller 50. Specifically, the wavelength of the laser light emitted from the light source 1 is variably controlled by the beam wavelength variable controller 50. Whereas the apparatus includes galvanometer mirrors 9, 11 for variably controlling the incident angle of the reference beam R, R′ in the previous embodiment, the hologram recorder A1 includes fixed mirrors 9′, 11′ instead in the present embodiment.

In this hologram recording/reproducing apparatus A1, which performs multiplex recording by such variable wavelength control, the spatial light modulator 5 forms mark pixel areas G1 at the position not overlapping the polarization line p (see FIG. 2). Thus, reading errors can be avoided in reproducing in wavelength multiplex methods.

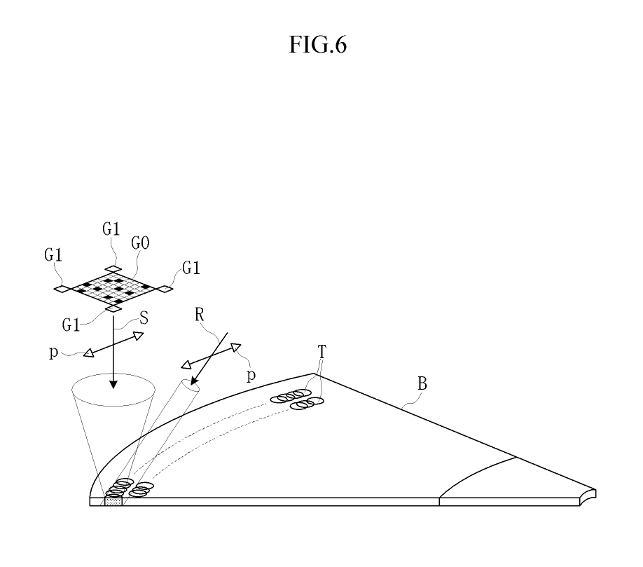

The hologram recording/reproducing apparatus illustrated in FIG. 6 is similar to the one illustrated in FIG. 1, but employs a so called shift multiple method, in which holograms are recorded by sequentially overlapping the unit recording areas T. A set of a data area H0 and mark areas H1 is recorded in each unit recording area T.

In this hologram recording/reproducing apparatus, which records holograms by the shift multiplex method, the spatial light modulator 5 forms mark pixel areas G1 at the position not overlapping the polarization line p (see FIG. 2). Therefore, readout errors are avoided in reproduction in shift multiplex methods.

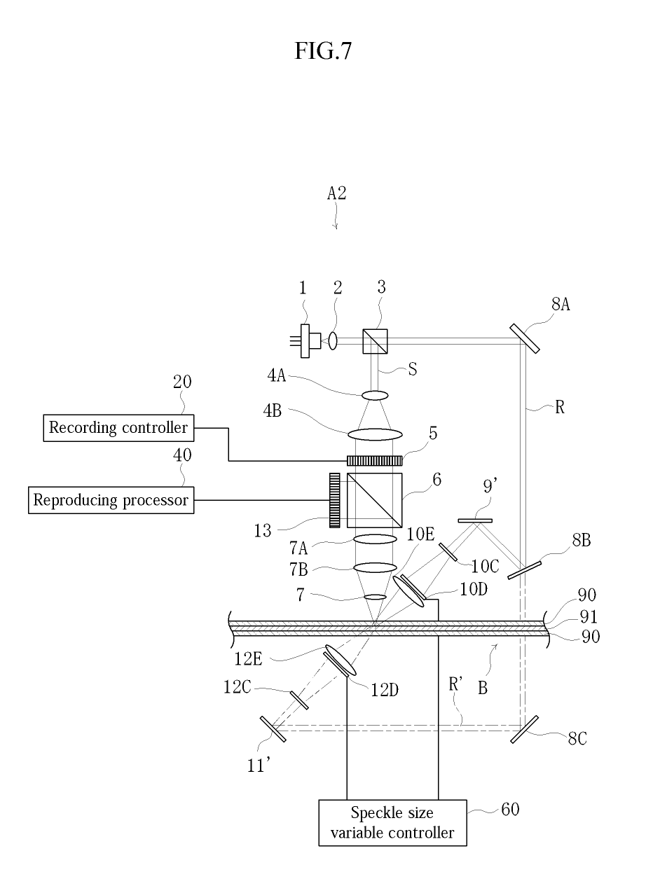

The hologram recording/reproducing apparatus A2 illustrated in FIG. 7 is configured to convert reference beams R, R′ into speckles and to perform multiple recording by variably controlling the size of the speckles. The hologram recording/reproducing apparatus A2 includes diffuser plates 10C, 12C, liquid crystal filters 10D, 12D, reference-beam objective lenses 10E, 12E, and a speckle size variable controller 60. Specifically, the reference beams R, R′ emitted from the fixed mirrors 9′, 11′ are converted into speckles by the diffuser plates 10C, 12C, respectively. Then, these reference beams R, R′ in the form of speckles pass by the liquid crystal filters 10D, 12D and the objective lenses 10E, 12E, respectively, and reach the unit recording area T. The speckle size is dependent upon the numeric apertures of the objective lenses 10E, 12E. Thus, when the speckle size variable controller 60 controls the voltage applied to the liquid crystal filters 10D, 12D, the numeric apertures of the objective lenses 10E, 12E are varied and the speckle size is varied accordingly. In this way, the speckle size variable controller 60 can variably control the speckle size.

In this hologram recording/reproducing apparatus A2, which performs multiple recording by variable control of the speckle size, the spatial light modulator 5 forms mark pixel areas G1 at the positions not overlapping the polarization line p (see FIG. 2). Therefore, reading errors can be avoided in reproduction in speckle multiplex methods

Further, if phase modulation devices are provided instead of the diffuser plates 10C, 12C, the phase code multiple method is performed. In the phase code multiple method, reading errors can be avoided in reproduction by forming mark pixel areas G1 at the positions not overlapping the polarization line p.

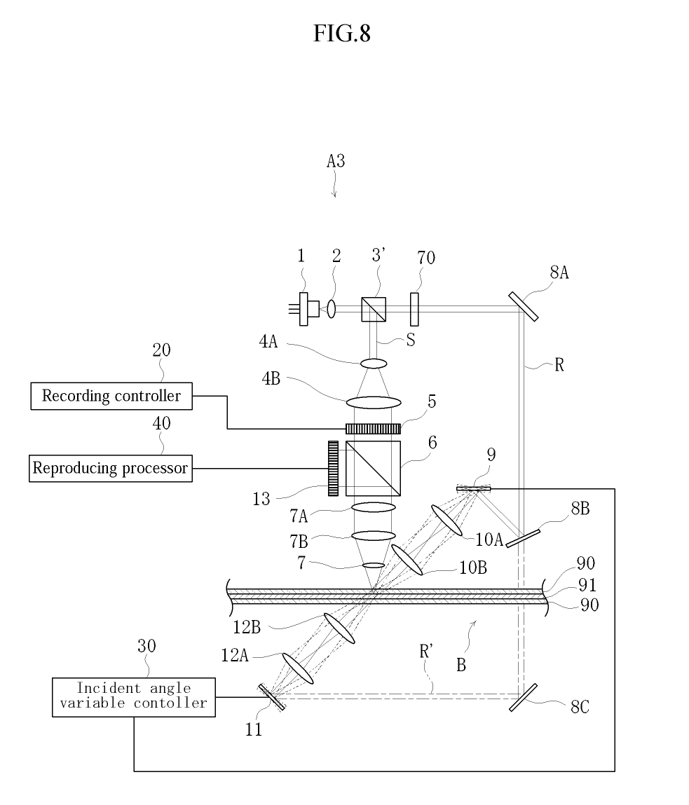

The hologram recording/reproducing apparatus A3 illustrated in FIG. 8 includes a polarizing beam splitter 3′ instead of the half mirror 3, and further includes a polarizing plate 70 on the optical path of the reference beams R, R′. The polarizing direction of the recording beam S and that of the reference beams R, R′ become different from each other when the beams are split by the polarizing beam splitter 3′. For example, the recording beam S has a vertical polarization while the reference beams R, R′ are converted to have a horizontal polarization. After that, the reference beams R, R′ pass through the polarizing plate 70, whereby the polarizing plate 70 converts the reference beams R, R′ to have the original vertical polarization. Therefore, the recording beam S and the reference beams R, R′ have the same polarizing direction on the hologram recording medium B. In this way, in the hologram recording/reproducing apparatus A3, reading errors can be avoided in reproduction by forming mark pixel areas G1 at the positions not overlapping the polarization line p.

1. A hologram recording/reproducing apparatus for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device,
wherein the spatial light modulator is controlled so as to form a data area corresponding to information to be recorded and a plurality of mark areas for detecting a position of the data area in the hologram recording medium in recording of the hologram, the mark areas being formed at positions not to be overlapped by a beam scattering region which may be generated along a polarizing direction of the reference beam on an outward side of the data area.

2. A hologram recording/reproducing apparatus for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device,
wherein the spatial light modulator is controlled so as to form a data area corresponding to information to be recorded and a plurality of mark areas for detecting a position of the data area in the hologram recording medium in recording of the hologram, and
wherein the hologram recording/reproducing apparatus further comprises a polarizer on an optical path of at least one of the recording beam and the reference beam, the polarizer being utilized for matching polarizing direction of the recording beam and the reference beam in recording, and for determining the polarizing direction so as not to cause any of the mark areas to be overlapped by a beam scattering region which may appear along the polarizing direction of the reference beam on an outward side of the data area.

3. The hologram recording/reproducing apparatus according to claim 1 or 2, wherein the spatial light modulator forms the mark areas adjacent to the data area.

4. The hologram recording/reproducing apparatus according to claim 3, capable of performing multiple recording of holograms including the data area and the mark areas by using an angular multiple method, a wavelength multiple method, a shift multiple method, a speckles multiple method or a phase code multiple method.

5. The hologram recording/reproducing apparatus according to claim 3, wherein the spatial light modulator forms the data area in a polygonal shape and the mark areas at a plurality of positions from which corners of the data area are locatable.

6. A hologram recording/reproducing method for recording a hologram by emitting a recording beam modulated by a spatial light modulator and a reference beam having a same wavelength as the recording beam onto a hologram recording medium so that the beams overlap each other with polarizing direction of the beams being matched to interfere with each other, and for reproducing the hologram by exposing the hologram recording medium storing the hologram to the reference beam to generate diffracted light and receiving the diffracted light by an imaging device,
wherein the spatial light modulator is controlled so as to form a data area corresponding to information to be recorded and a plurality of mark areas adjacent to the data area for detecting a position of the data area in the hologram recording medium in recording of the hologram, the mark areas being formed at positions not to be overlapped by a beam scattering region which may be generated along a polarizing direction of the reference beam on an outward side of the data area.

7. A hologram recording/reproducing method for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device,
wherein the spatial light modulator is controlled so as to form a data area corresponding to information to be recorded and a plurality of mark areas adjacent to the data area for detecting a position of the data area in the hologram recording medium in recording of the hologram, and polarizing direction of the recording beam and the reference beam are matched, and the polarizing direction of at least one of the recording beam and the reference beam is determined so as not to cause any of the mark areas to be overlapped by a beam scattering region which may appear along the polarizing direction of the reference beam on an outward side of the data area.

8. A hologram recording medium to be used in a hologram recording/reproducing apparatus for recording a hologram by emitting a recording beam modulated by a spatial light modulator and a reference beam having a same wavelength as the recording beam onto a hologram recording medium so that the beams overlap each other to interfere with each other, and for reproducing the hologram by exposing the hologram recording medium storing the hologram to the reference beam to generate diffracted light and receiving the diffracted light by an imaging device,
wherein a data area corresponding to information to be recorded and a plurality of mark areas for detecting a position of the data area are formed in recording of the hologram in the hologram recording medium, the mark areas being formed at positions not to be overlapped by a beam scattering region which may be generated along a polarizing direction of the reference beam on an outward side of the data area.
